(19) United States
(12) Patent Application Publication
(10) Pub. No.: US 2005/0117131 A1
(43) Pub. Date: Jun. 2, 2005

(54) Projection adapter and combination of such adapter with a display

(76) Inventors: Marina Khazova, Oxfordshire (GB); Grant Bourhill, Stow-on-the-Wold (GB); Bronje M. Musgrave, Sutton Courtenay (GB)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 10/970,336

(22) Filed: Oct. 21, 2004

(30) Foreign Application Priority Data
Oct. 23, 2003 (GB) 0324718.6

(51) Int. Cl. G03B 21/00

(52) U.S. Cl. 353/120; 348/832

(57) ABSTRACT

A projection adapter is provided for attaching to a display so as to form a projected enlarged image of an image displayed by the display. The display is of the direct view reflective or transflective type and does not require any modification when cooperating with the projection adapter to function as a projection display. The adapter comprises an illumination section and a projection section with optional beam steering optics supported by a common support arrangement. A front optical element is arranged to overlay the display with the projection adapter in use. The illumination section forms an off-axis image of a light source and the front optical element images light reflected by the reflective or transflective display to an image which is laterally displaced from the light source image. The projection section projects a magnified image of the image displayed by the display onto a screen which may form part of or be distinct from the adapter.

### TECHNICAL FIELD

The present invention relates to a projection adapter which may be used with a direct view display. The invention also relates to a combination of such an adapter and a display.

### BACKGROUND

Devices, such as mobile or cellular telephones, personal digital assistants (PDAs), personal game consoles and vehicle dashboards, of known types generally incorporate some form of a display such as a liquid crystal display (LCD). Known types of LCDs for such devices may operate in a variety of modes, such as a reflective mode, a transmissive mode or a transflective mode. A reflective mode LCD makes use of ambient light or external lighting to display information. A transflective LCD may operate in the reflective mode, again making use of ambient light for illumination, or in a transmissive mode if ambient illumination is insufficient. A backlight is required for the transmissive mode.

Portable devices are generally powered by batteries which require recharging from time to time. In order to maximise device use between battery recharging, it is desirable to reduce the power consumption of such devices. The reflective mode of LCDs generally requires substantially less power than the transmissive mode and thus maximises the time between recharging of the batteries.

U.S. Pat. No. 5,629,806 discloses a display arrangement for providing private viewing and for displaying a relatively large image from a small direct view display. The arrangement comprises an image display, such as a cathode ray tube, electro-luminescent display or direct view back-lit transmissive LCD, together with focusing, conjugating and folding optics. The conjugating optics include a retro-reflector and a beam splitter.

FIG. 1 of the accompanying drawings illustrates a known type of overhead projector of the reflection type for images fixed on transparencies. The projector comprises a light source including a condensing optic 1 for illuminating a transparency 2 carrying an image to be projected. The transparency 2 is disposed on a reflective Fresnel lens 3 with the axis of the lens 3 being laterally spaced from the axis of the condensing optic 1. The lens 3 images the light source at an entrance pupil of a projection lens 4, whose axis is also laterally spaced from the axis of the lens 3 and from the axis of the condensing optic 1. A folding mirror 5 directs light onto a projection screen (not shown) for displaying the projected image.

U.S. Pat. No. 5,970,418 discloses a wireless handset telephone as illustrated in FIG. 2 of the accompanying drawings. The telephone includes a virtual image display 14 which reflects the image from a direct view display 26 so that the virtual image is viewable while the telephone is held to the ear of a user. The display comprises a curved mirror 22, a partially reflective/transmissive optical element 24, the display 26 and a rotating base 28.

U.S. Pat. No. 6,489,934 discloses a mobile or cellular telephone with a built-in optical projector. The optical projector is distinct from a direct view display of the telephone and comprises a high intensity lamp, a collimating lens, a transmissive LCD (which is distinct from the LCD used in the direct view mode) and a projection lens.

U.S. 2002/0063855 discloses a small video projector which is functionally integrated into a device such as a mobile telephone or a personal digital assistant. The projector includes an internal light source, a micro-display and a projection arrangement.

At the CeBIT2002 computer show in Hanover, Germany, Siemens AG disclosed a miniature daylight projector which may be connected to a mobile telephone with a suitable interface. The projector comprises a light source in the form of a light emitting diode array for illuminating a micro-display (distinct from the display of the mobile telephone) through a beam splitter. A projection lens projects the resulting image onto a suitable projection screen or surface.

JP2002-268005 discloses a portable projection display, which projects the image from a display element or its intermediate image on the eye of an observer.

JP2002-027060 discloses a mobile telephone including an overhead projection function. Information stored in a memory is displayed by a display panel. The displayed information is illuminated by an internal light source and reflected and projected through a magnifying lens onto a projection screen.

GB2360664 discloses a mobile telephone incorporating a projection arrangement and a projection screen, which may be stored or unfolded for use.

U.S. Pat. No. 6,595,648 discloses a projection display as illustrated in FIG. 3 of the accompanying drawings. The display comprises a light source, comprising a lamp and collecting optics 20, 21, a condensing optic 1, a field stop 30 and a condensing optic 25, which forms an image 33 of the light source at a first reflecting surface of a turning prism 31. Light from the light source illuminates an LCD 10 provided with a volume reflection hologram 32 permanently attached to the rear surface of the transmissive LCD. The hologram 32 acts as a lens which forms an image 34 on a second reflecting surface of the turning prism 31. A projection lens 4 forms a final image 35 at a projection screen (not shown). The image 34 of the light source is laterally spaced from the image 33 of the light source. The hologram 32 thus functions as a reflector and off-axis lens.

Valliath et al, “Design of Hologram for Brightness Enhancement in Colour LCDs”, SID98 Digest 44.5 L, PP1139-1142, 1998 discloses the use of a transmission hologram for brightness enhancement of a front-illuminated reflective LCD. The hologram is permanently attached to a front surface of the LCD and, when suitably illuminated, directs light into a viewing region of the display.

### SUMMARY

According to a first aspect of the invention, there is provided a projection adapter for cooperating with a direct view reflective or transflective display, which is physically distinct from the adapter, to form a projected enlarged image of an image displayed by the display, the adapter comprising an illumination section, a projection section and a support arrangement supporting the illumination section and the projection section.

The support arrangement may comprise an attachment for removably attaching the adapter to the device.

The adapter may comprise a front optical element for overlying the display at least when the adapter is in use.

A or the front optical element may be disposed in an illumination light path and in a projection light path at least when the adapter is in use.

The front element may be an optically converging element.

The front element may be a lens. The lens may be a Fresnel lens.

The front element may be a hologram. The hologram may be a volume transmission hologram. The hologram may be supported by the support arrangement. As an alternative, the hologram may be part of the device. The hologram may overlie an image-forming part of the display.

The illumination section may form a first image of a light source and the front element may form a second image of the light source laterally spaced from the first image at least when the adapter is in use. Each line from the first and second images normally intersecting a plane containing a display surface of the display may intersect the plane outside the display surface.

The adapter may comprise a first reflector for forming a bent illumination light path.

The adapter may comprise a second reflector for forming a bent reflection light path.

The first and second images may be formed substantially at the first and second reflectors, respectively. The first and second reflectors may comprise facets of a reflective prism.

The projection section may comprise a projection optic. The adapter may comprise a stop defining an input aperture to the projection optic.

The illumination section may comprise a condensing optic.

The illumination section may comprise a light source. The light source may comprise a plurality of differently coloured light emitters the differently coloured emitters may be arranged to operate time-sequentially.

The projection section may comprise a polariser.

The adapter may comprise a projection screen supported by the support arrangement.

The front element may comprise a plurality of sub-elements which are laterally offset from each other. The second reflector may comprise a plurality of non-parallel reflecting surfaces.

According to a second aspect of the invention, there is provided a combination of an adapter according to the first aspect of the invention and a direct view reflective or transflective display.

The display may be part of a communication device, such as a mobile cellular telephone. As an alternative, the display may be part of a personal digital assistant. As a further alternative, the display may be part of a personal game console. As yet another alternative, the display may be at least part of an in-vehicle display.

The display may be liquid crystal display.

It is thus possible to provide an adapter which adds to a reflective or transflective display the function of a projection display. No modification of the display is necessary and the adapter may make use of a direct view reflective or transflective display, for example forming part of a portable or other device. Thus, no additional display is necessary and no internal light source is required. Power consumption of such a device is not, therefore, compromised by the projection function. The adapter may be attached to the device when a projection display is required and may otherwise be detached from the device. The functionality of such a device may thus be increased.

### BRIEF DESCRIPTION OF DRAWINGS

FIG. 1 is a diagram illustrating a known type of overhead projector;

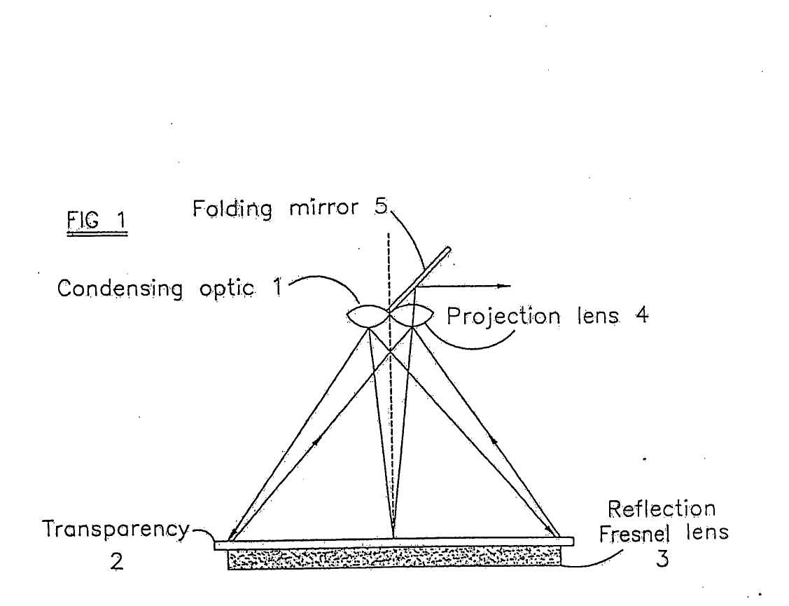

FIG. 2 illustrates a known type of mobile telephone incorporating a virtual display;

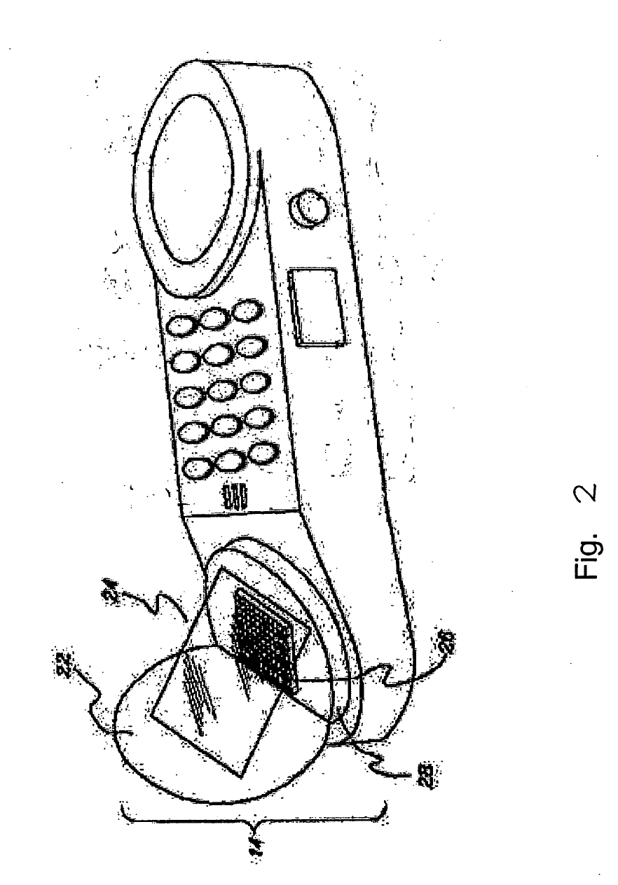

FIG. 3 is a diagram illustrating another known type of projection display;

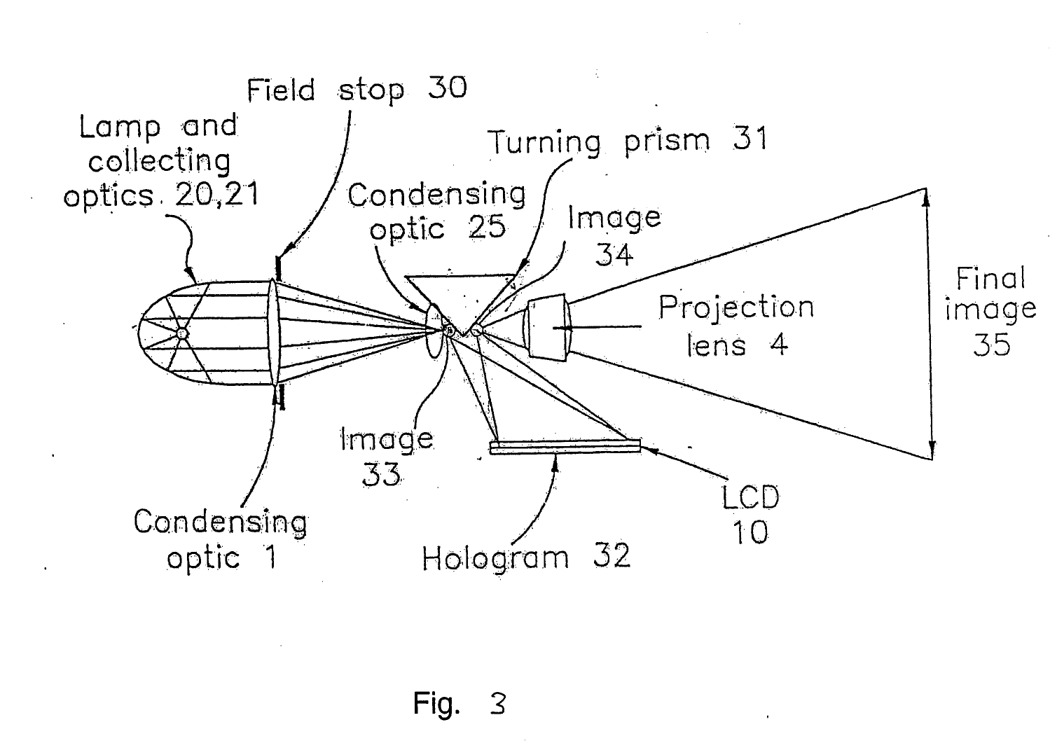

FIG. 4 is a cross-sectional diagram illustrating a projection adapter constituting an embodiment of the invention;

FIG. 5 is a cross-sectional diagram illustrating a projection adapter constituting another embodiment of the invention;

FIG. 6 is a cross-sectional diagram illustrating operation of an adapter with an off-axis lens constituting an embodiment of the invention;

FIG. 7 is a diagram illustrating the operation of a transmission hologram as a front optical element in a projection adapter;

FIG. 8 is a cross-sectional diagram illustrating a projection adapter constituting another embodiment of the invention;

FIG. 9 is a cross-sectional diagram illustrating a projection adapter constituting a further embodiment of the invention;

FIG. 10 is a cross-sectional diagram illustrating a projection adapter constituting another embodiment of the invention;

FIG. 11 is a cross-sectional diagram illustrating a projection adapter constituting a further embodiment of the invention;

FIG. 12 is a cross-sectional diagram illustrating a projection adapter constituting another embodiment of the invention;

FIG. 13 is a cross-sectional diagram illustrating a projection adapter constituting a further embodiment of the invention;

FIG. 14 is a cross-sectional diagram illustrating a projection adapter constituting another embodiment of the invention;

FIG. 15 is a diagram illustrating another view of the adapter of FIG. 14;

FIG. 16 illustrates beam turning mirrors in two different modes of operation of a projection adapter;

FIG. 17 illustrates another type of beam turning mirror arrangement;

FIG. 18 illustrates a further type of beam turning mirror arrangement;

FIG. 19 is a cross-sectional diagram illustrating a projection adapter constituting another embodiment of the invention; and

FIG. 20 is a diagram illustrating the use of a stop aperture in a projection aperture.

Like referencing rules refer to like parts throughout the drawings.

### DETAILED DESCRIPTION

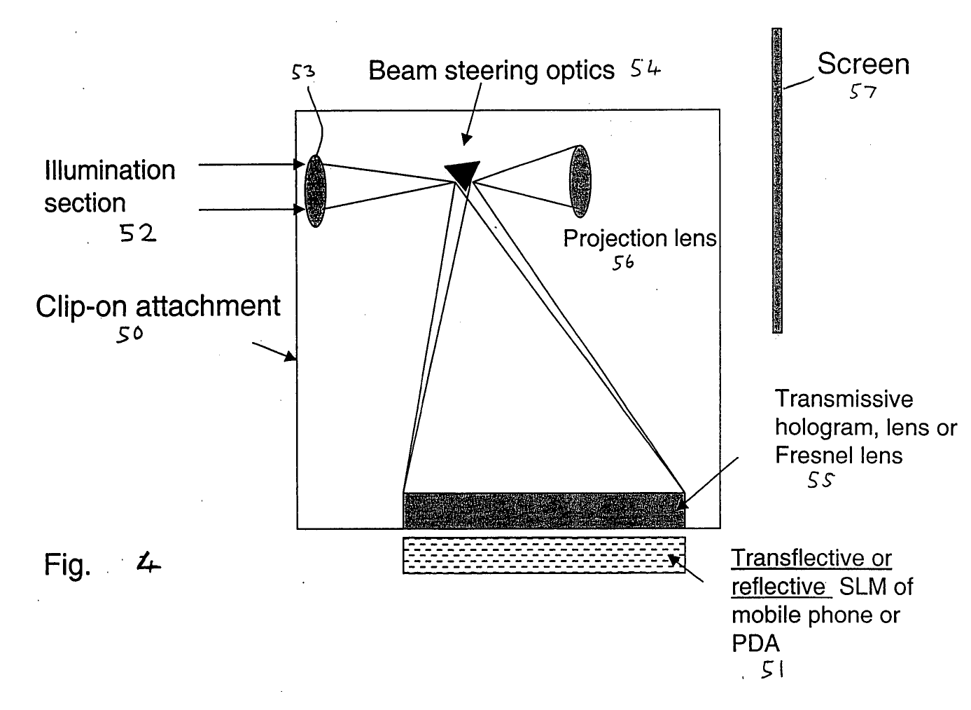

FIG. 4 illustrates a projection adapter 50 in the form of a clip-on attachment for removeably attaching to a reflective or transflective display, for example in a mobile or cellular telephone, a personal digital assistant (PDA), a game console or a vehicle dashboard. The attachment 50 includes a common support, such as a suitable enclosure, for all of the components and devices forming the adapter. The display 51 may, for example, be a spatial light modulator (SLM) such as a liquid crystal device (LCD).

The adapter 50 has an illumination section illustrated in general at 52 and including a condensing optic 53. Light emitting devices forming part of the illumination section 52 may be supported by or disposed in the adapter 50 or may be external thereto.

The adapter further comprises beam steering optics 54 which direct light from the illumination section to a front optical element 55. The element 55 may comprise a lens such as a Fresnel lens or a hologram such as an transmission hologram. The element 55 is illustrated as forming part of the adapter 50 but may, in some embodiments such as when the element 55 is a transmission hologram, be permanently attached to the front of the display 51.

The adapter 50 further comprises a projection section illustrated as a projection lens 56. Light reflected from the display 51 is reflected by the optics 54 and projected by the projection lens 56 to a projection screen 57, which may be separate or distinct from the adapter 50 or may form a part thereof. For example, the screen 57 may be attached to the adapter 50 and may be foldable for storage and unfoldable for use. As an alternative, the adapter may be used with an in-vehicle display and the projection screen 57 may be incorporated in a vehicle windscreen.

The illumination section 52 forms an image of the light source substantially at one reflecting surface of the beam steering optics 54. The optics 54 reflect the incoming light so as to illuminate the display 51 via the front optical element 55. The display 51 spatially modulates and reflects the light with an image to be projected and the element 55 forms an image of the light source which is laterally displaced from the image formed by the illumination section 52. This image is formed substantially at a second reflecting surface of the optics 54, which reflects the light to the projection lens 56.

It is thus possible to provide a projection adapter which increases the functionality of devices incorporating displays by allowing enlarged images to be projected from a relatively small image source. No additional LCD or other SLM is required in order to generate the projected image. Instead, the adapter cooperates with a conventional reflective or transflective display provided on the device for direct viewing so that no modification of the device is required. The same adapter may be used, for example, for different models of personal communication devices. The brightness of the projected image does not depend on the brightness of the direct view display. Reflection from the display relies on the internal reflection arrangements of the LCD so that substantially no problems with parallax arise. The adapter has no effect on operation of the device in the direct view mode of the display because the adapter can easily be removed for direct viewing. It is thus possible to provide a portable and relatively low cost projection adapter for use with an existing display requiring no modification.

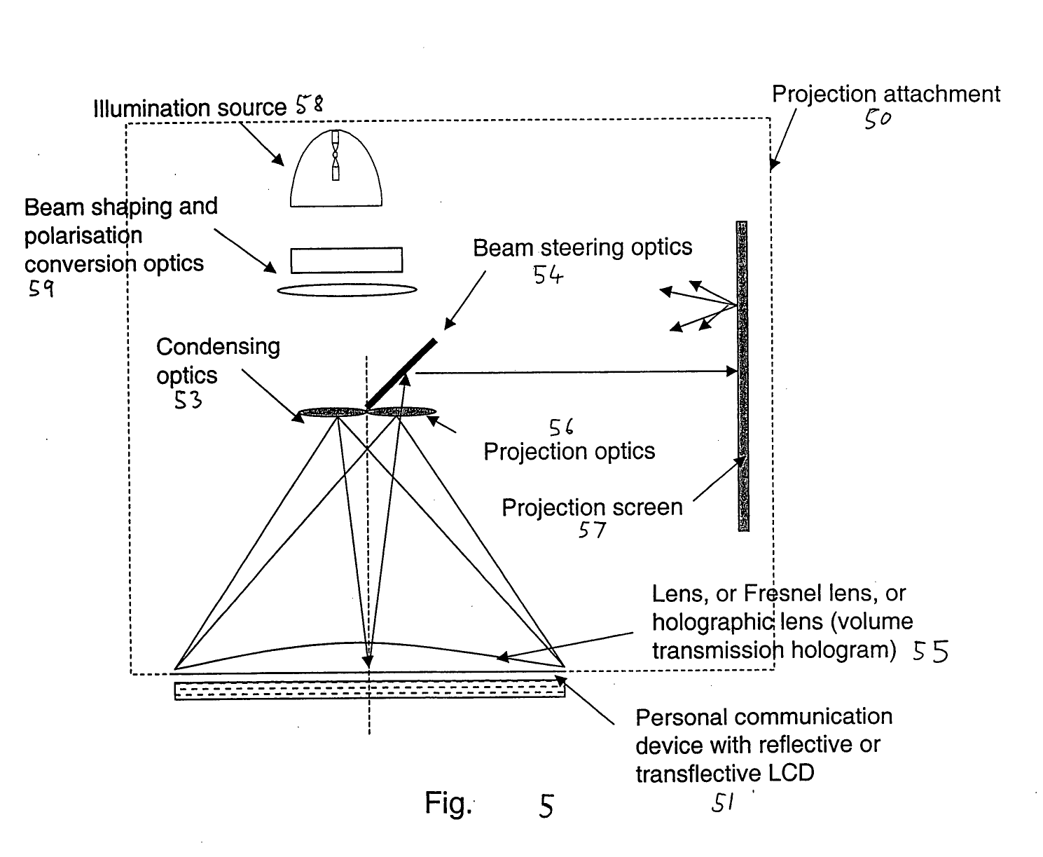

FIG. 5 illustrates in more detail an example of a projection attachment or adapter 50 of the type shown in FIG. 4. In addition to the condensing optics 53, the illumination section comprises an illumination source 58, illustrated as a lamp and a parabolic reflector, and beam shaping and polarisation conversion optics 59. The beam steering optics 54 comprise a plane mirror and the projection screen 57 is shown as being internal to or part of the adapter 50.

Light from the illumination source 58 is “processed” by the beam shaping optics, for example so as to transform a round or elliptical profile of light from the illumination source 58 to a rectangular or hexagonal shape. Also, the intensity distribution of the light is homogenised. Thus, the efficiency and uniformity of illumination of the LCD 51 are improved. The polarisation conversion optics convert unpolarised light from the source 58 into polarised light for illuminating the LCD 51. In general, LCDs operate on polarised light and, by matching the polarisation of the incident light to the required polarisation, brightness and efficiency may be improved.

The condensing optics 53 and the projection optics 56 are laterally spaced from each other. The projection optics 56 project the image displayed on the display 51 via the plane mirror 54 onto the projection screen 57 to allow a magnified image to be viewed, for example, more conveniently by several viewers.

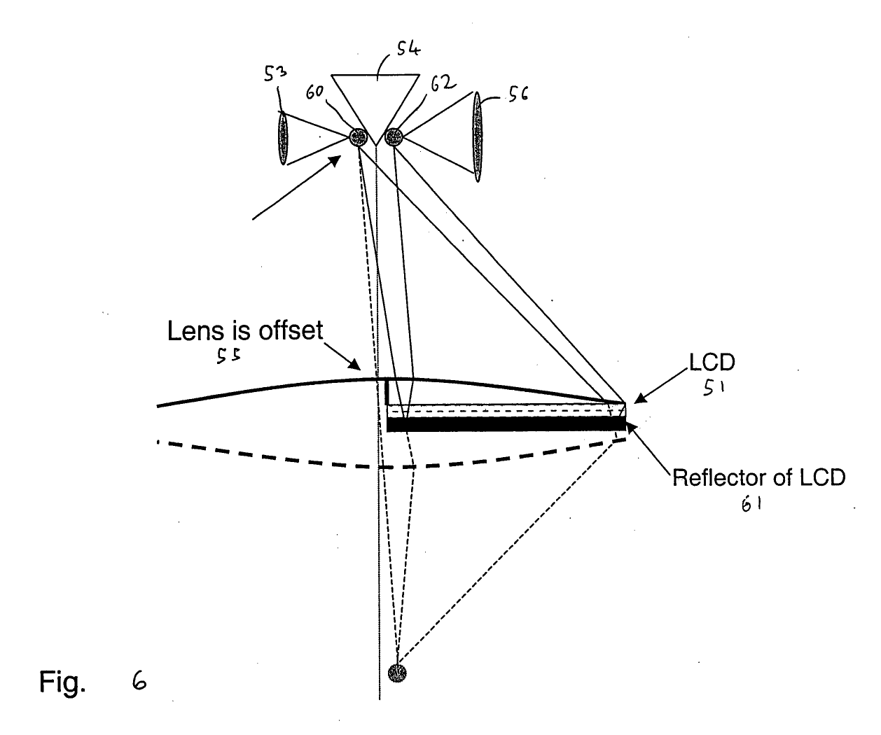

FIG. 6 illustrates diagrammatically a modified arrangement of the projection adapter. The illumination section including the optic 53 forms an image 60 at a first reflecting surface of the beam steering optics 54, which are illustrated as a reflective prism in this embodiment. Light reflected from the prism 54 is incident on the lens 55, which is offset. In particular, a line drawn from the image 60 so as to intersect orthogonally a plane containing the image plane of the LCD 51 intersects that plane outside the LCD image.

Light reflected by the prism 54 passes through the lens 55 and is modulated by the LCD and reflected by a reflector 61 of the LCD. The lens 55 images the reflected light so as to form an image 62 of the light source at a second reflecting surface of the prism 54. The image 62 may also be offset so that a line drawn from the image 62 perpendicularly to the plane containing the LCD display surface does not intersect that surface.

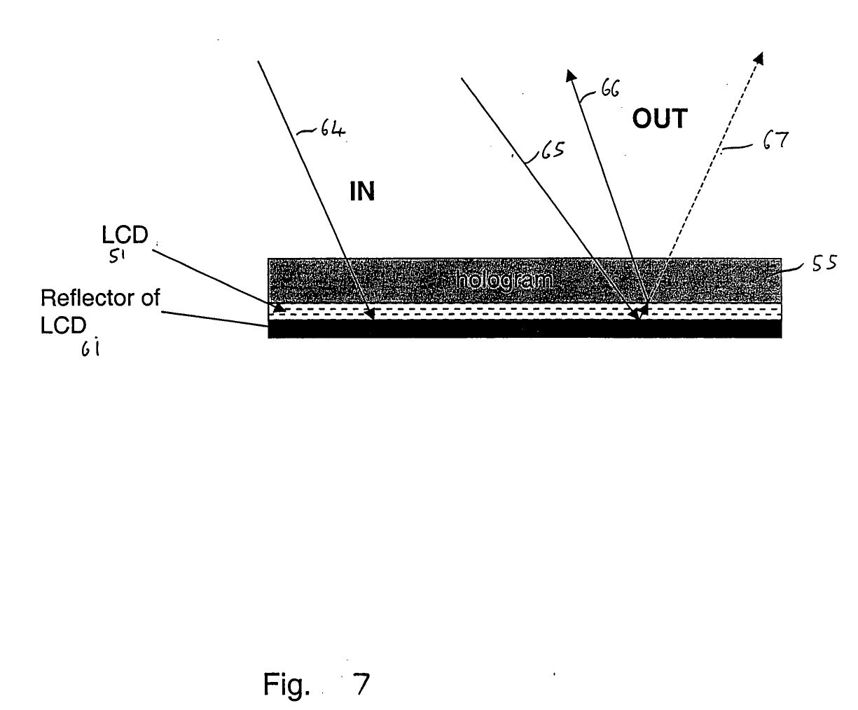

FIG. 7 illustrates the use of a volume transmission hologram as the front optical element 55. The hologram 55 functions as an off-axis lens when correctly illuminated by light reflected from the internal mirror or reflector 61 of the LCD 51. The hologram forms an image of the light source in a similar manner to a lens or a Fresnel lens with the image being above the LCD 51 and laterally spaced or displaced from the illumination pupil or image 60.

The hologram 55 has substantially no function for incident light from the illumination source because the angle of incidence does not satisfy the Bragg conditions. Thus, incident light passing through the hologram 55 is not diffracted as illustrated by the incoming light ray at 64. Similarly, the hologram 55 performs substantially no function when illuminated by ambient light or with a transflective LCD 51 operating in the transmissive mode with a backlight.

The hologram 55 and the illumination provided by the illumination section are such that light 67 reflected from the internal reflector 61 of the LCD is incident on the hologram 55 at an angle which satisfies the Bragg conditions for efficient diffraction of light. Thus, light which is incident in the direction illustrated at 65 and reflected from the reflector 61 fulfils the Bragg conditions and is diffracted by the hologram 55 as illustrated at 66 so as to form the image 62. Any light which is not diffracted but is reflected, for example at the reflector 61 or at interfaces within the structure of the LCD 51, is reflected as illustrated at 67 and does not enter the entrance pupil of the projection section.

The “holographic lens” 55 may be recorded as a volume transmission hologram in a variety of high resolution light-sensitive materials, such as silver halide, dichromated gelatin or various photopolymers, for example available from DuPont. In order to increase the efficiency of light utilisation, the spectral response of the holographic lens may be designed to match the spectral characteristics of the illumination source. Similarly, in order to improve efficiency of light utilisation, the spectral response of the holographic lens may be arranged to match the spectral transmission of colour filters within the LCD 51. The hologram 55 may be designed as a continuous element for cooperating with the colour filters of the LCD 51. This allows substantial relaxation of the tolerances on alignment of the adapter 50 with the associated portable device because the holographic lens does not need to be accurately registered with the pixel structure of the LCD 51.

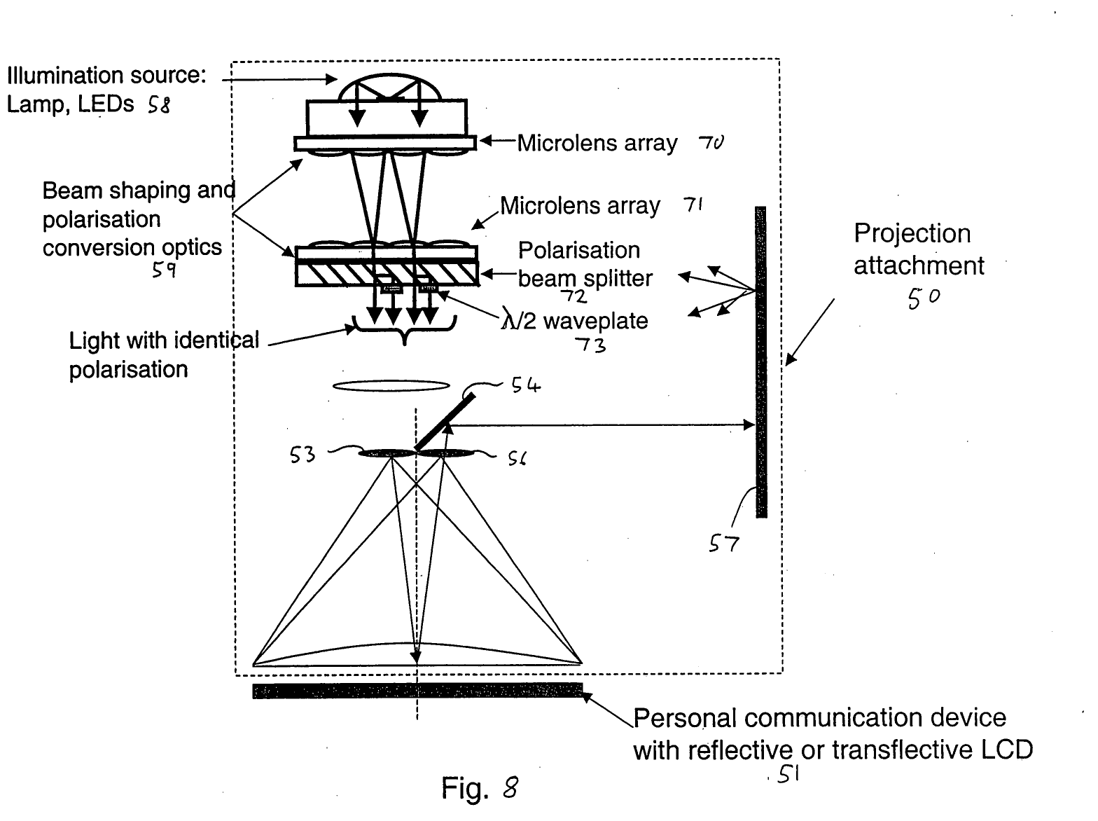

FIG. 8 illustrates an example of a polarisation conversion optical system forming part of the optics 59. The system comprises microlens arrays 70 and 71, a polarisation beam splitter array 72 and a set of half wave plates 73. The corresponding microlenses of the arrays 70 and 71 direct light into respective ones of the polarisation beam splitters 72. These beam splitters are such that light having a first polarisation is transmitted whereas light having the orthogonal polarisation is reflected internally twice so as to leave the beam splitter in the same direction. This light passes through a respective half wave plate 73 so that its polarisation direction is changed by 90 degrees. Thus, light of the same polarisation is supplied by the polarisation conversion optics.

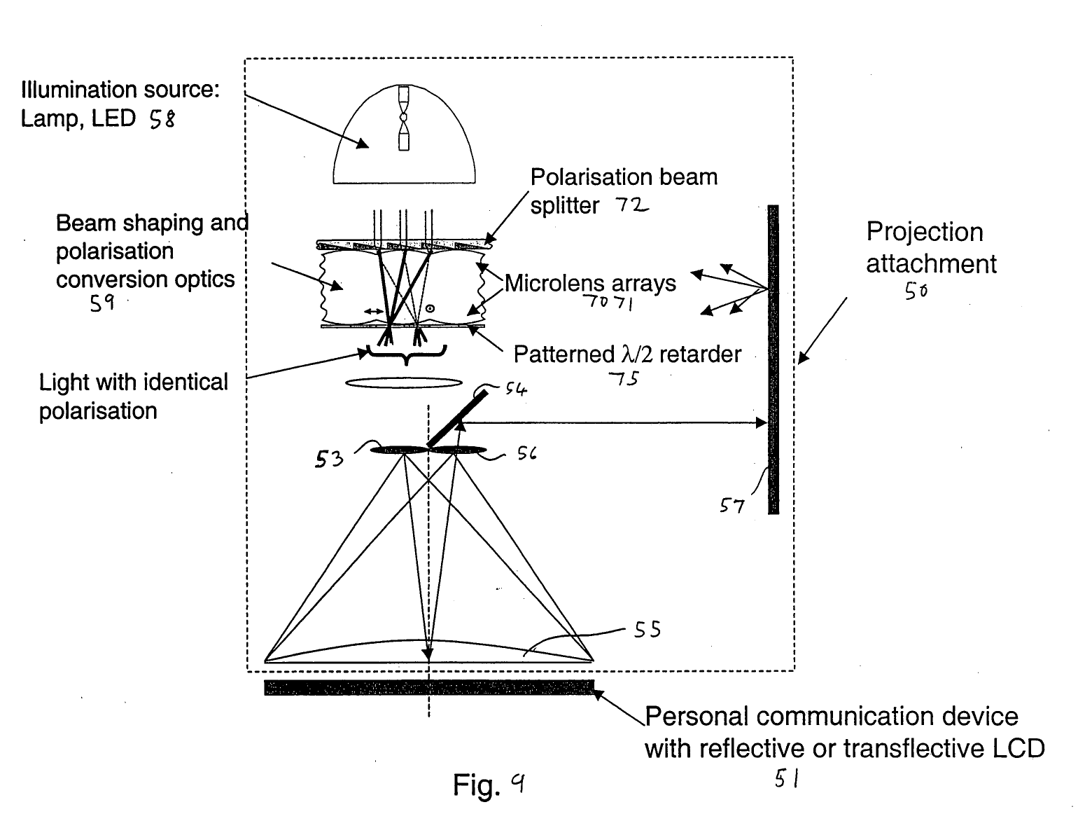

FIG. 9 illustrates an alternative polarisation conversion optical arrangement of the type disclosed in EP 1197766, the contents of which are incorporated herein by reference. In this arrangement, the patterned half wave plate is replaced by a patterned half wave retarder 75 and the order of the polarisation beam splitter 72 and the micro lens arrays 70 and 71 is different from that illustrated in FIG. 8. Operation of this arrangement is described in EP 1197766 and will not therefore be described further herein.

As a further alternative, the polarisation conversion optics may be embodied as a polarisation recovery light pipe. Such a light pipe is available from OCLI Inc. and will not be described further.

As yet a further alternative, other types of polarisation conversion optics or polarised light sources may be used.

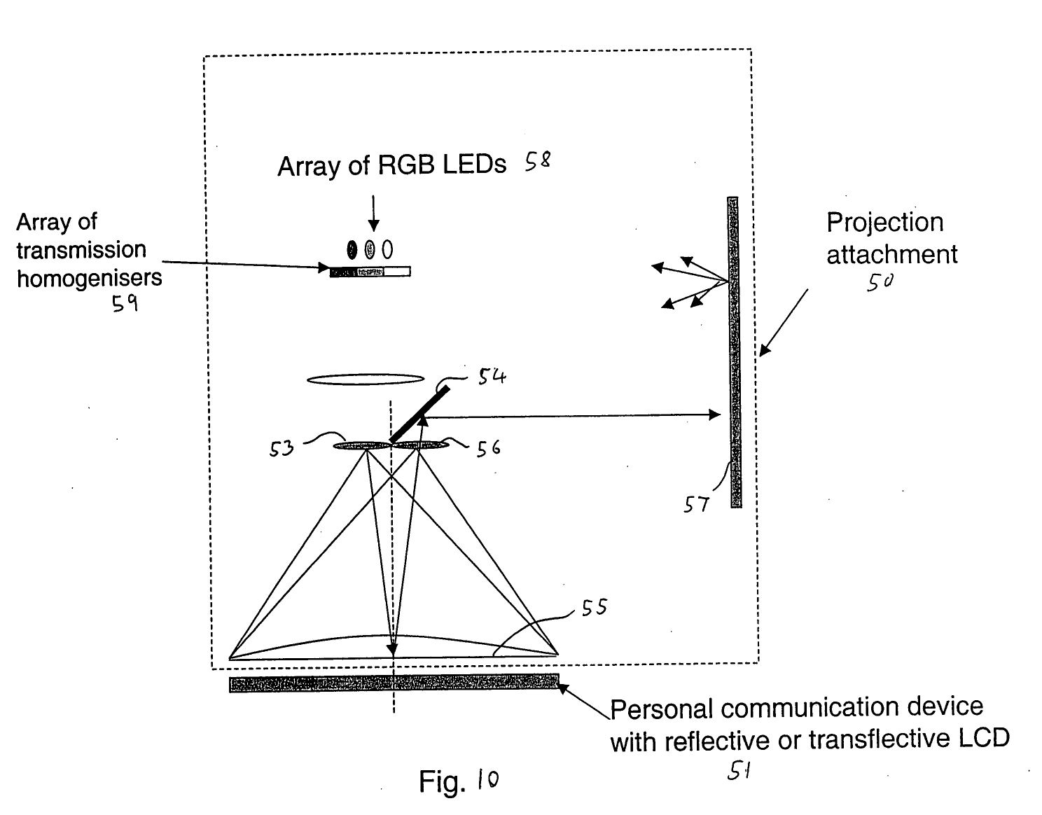

FIG. 10 illustrates an alternative arrangement, in which the illumination source 58 comprises an array of red (R), green (G), and blue (B) light emitting diodes (LEDs). In this case, each LED is provided with a transmission-type homogeniser as the array 59. Such homogenisers are designed to improve the uniformity and to reshape the illumination profile and may also be used to assist in matching the angular characteristics of the individual LEDs. Such homogenisers may be embodied as diffractive or refractive optical elements.

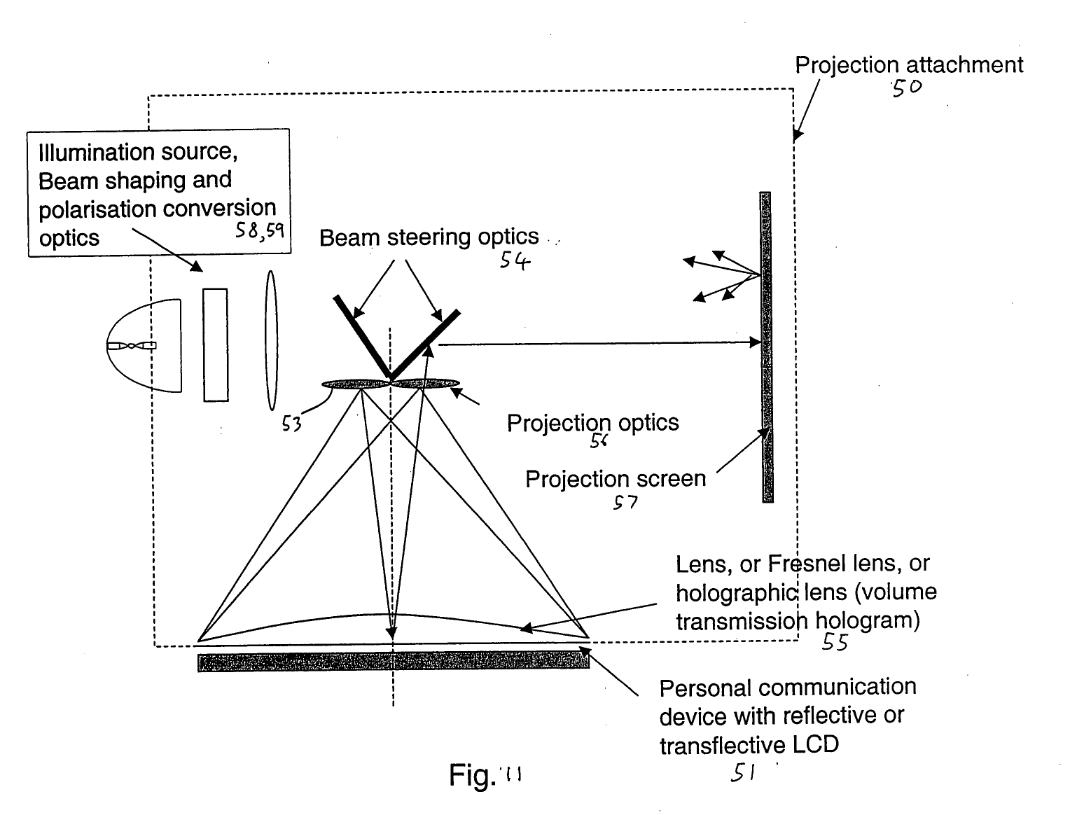

FIG. 11 illustrates an arrangement which differs from that shown in FIG. 5 in that the beam steering optics 54 comprise a further reflector for bending the illumination light path within the adapter 50. Such an arrangement allows a more compact design to be achieved.

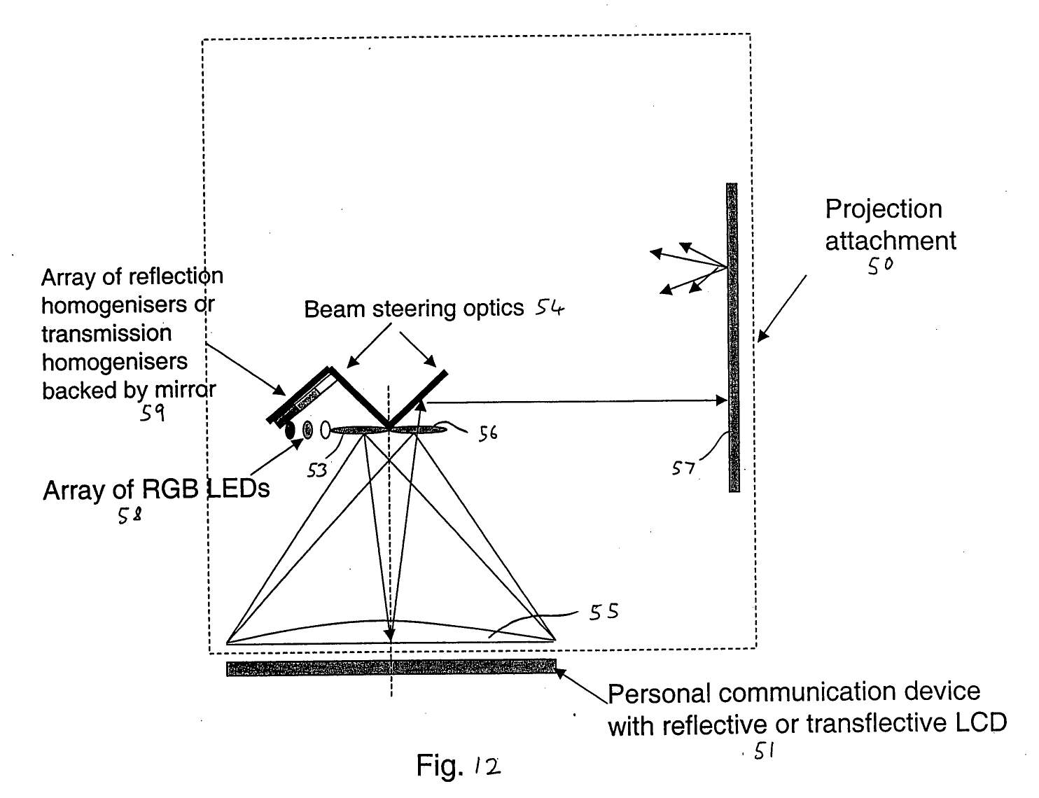

FIG. 12 illustrates an adapter 50 which differs from that shown in FIG. 11 in respect of the illuminating source and the beam shaping and polarisation conversion optics. In particular, the illumination source 58 comprises an array of LEDs of the type illustrated in FIG. 10. Also, the optics 59 comprise an array of reflection homogenisers or an array of transmission homogenisers of the type shown in FIG. 10 provided with a rear mirror. Such an arrangement allows a very compact adapter 50 to be provided.

In the embodiments illustrated in FIGS. 10 and 12, the differently coloured. LEDs may operate simultaneously or time-sequentially and red, green and blue colour component images are likewise displayed time-sequentially and in synchronism by the display 51. Time-sequential colour systems are known and will not be described further.

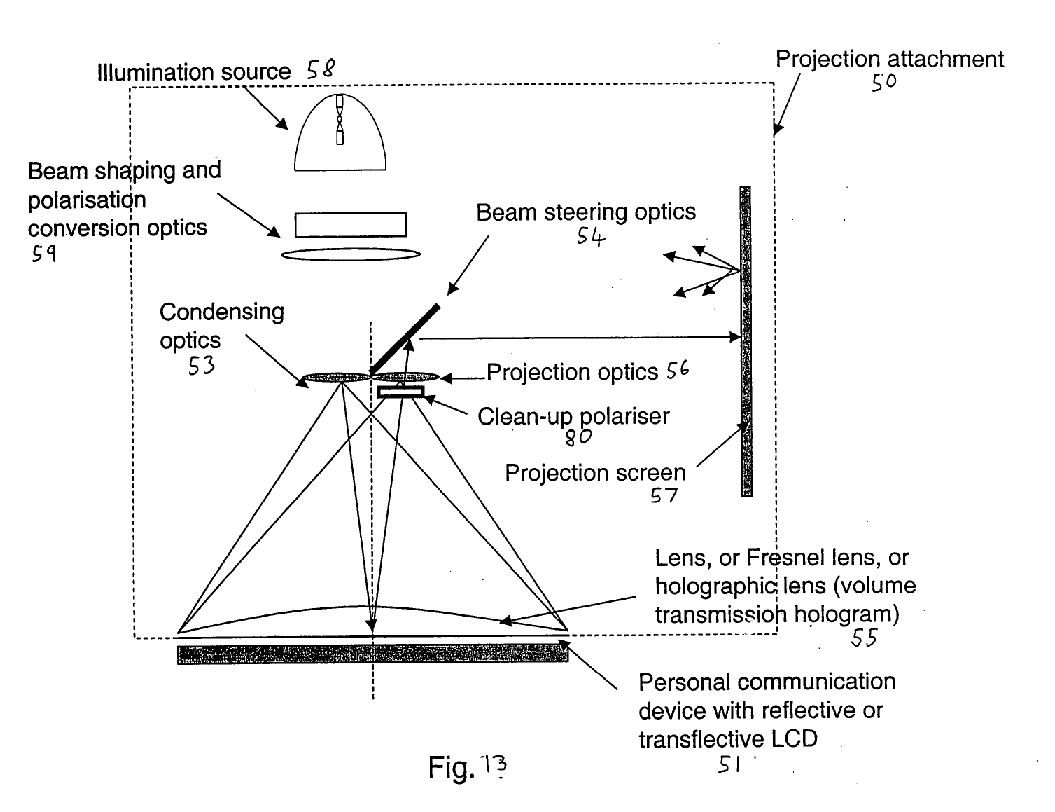

FIG. 13 illustrates a projection adapter 50 which differs from that shown in FIG. 5 in that a clean-up polariser 80 is disposed between the projection optics 56 and the front optical element 55. The light reflected from the LCD 51 is generally polarised and the polariser 80 is oriented so as to pass light of this polarisation and to attenuate or reject light of other polarisations. Thus, any light from a source other than the LCD 51 directed towards the projection optics 56 is attenuated or extinguished and the contrast ratio of the projection display is improved. For convenience and compactness, the polariser 80 is disposed adjacent the entrance pupil of the projection optics 56.

As an alternative, the polariser 80 may be disposed downstream of the projection optics 56. For example, the polariser may be in the form of a reflective polariser, such as a Moxtek wire grid polariser, and may be combined in the beam steering optics 54 as a single polarising and reflecting element.

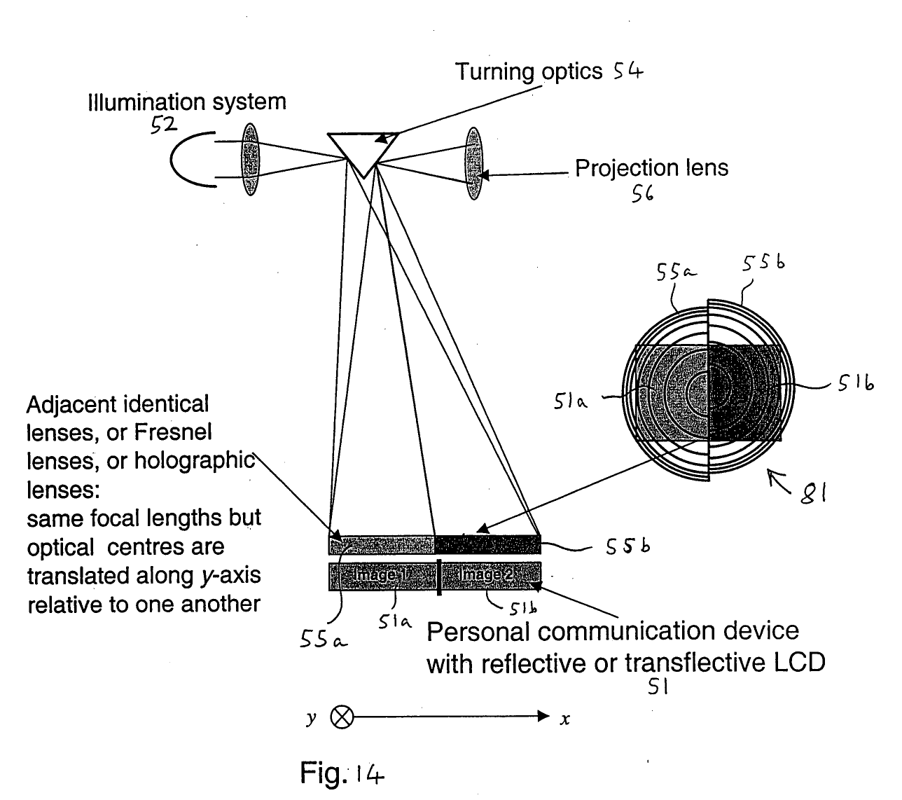

FIG. 14 illustrates a modified arrangement for projecting two different images, for example to be displayed side-by-side and spatially separated or contiguous on the projection screen. Alternatively, the images may overlap each other, for example on a high gain directional projection screen. The adapter of FIG. 14 differs from that shown in FIG. 4 in that the front optical element 55 comprises sub-elements 55a and 55b which are laterally offset with respect to each other. Each of the sub-elements 55a and 55b comprises a lens, Fresnel lens or holographic lens having the same focal length but with their optical centres translated or offset relative to each other in the direction of the y axis perpendicular to the plane of the main part of FIG. 14. This is illustrated in the inset at 81 in FIG. 14.

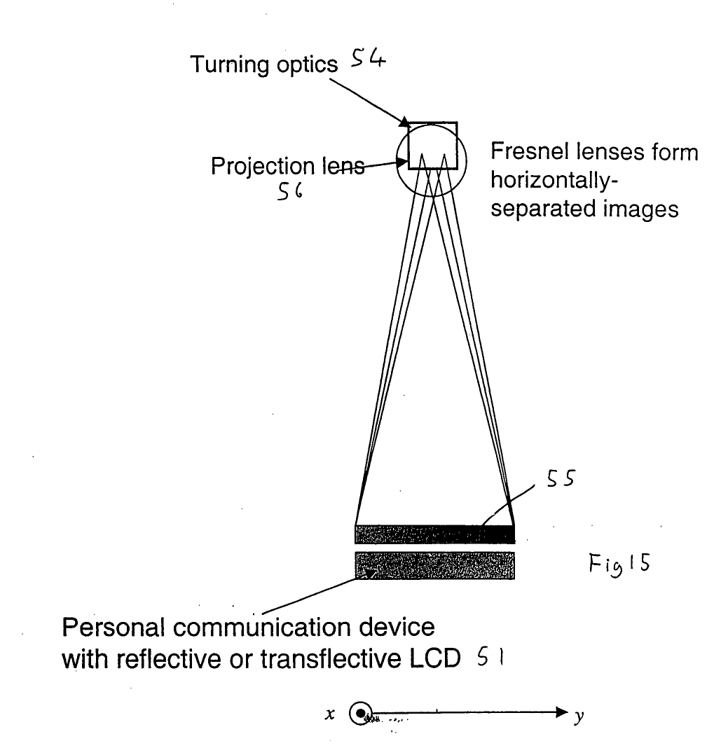

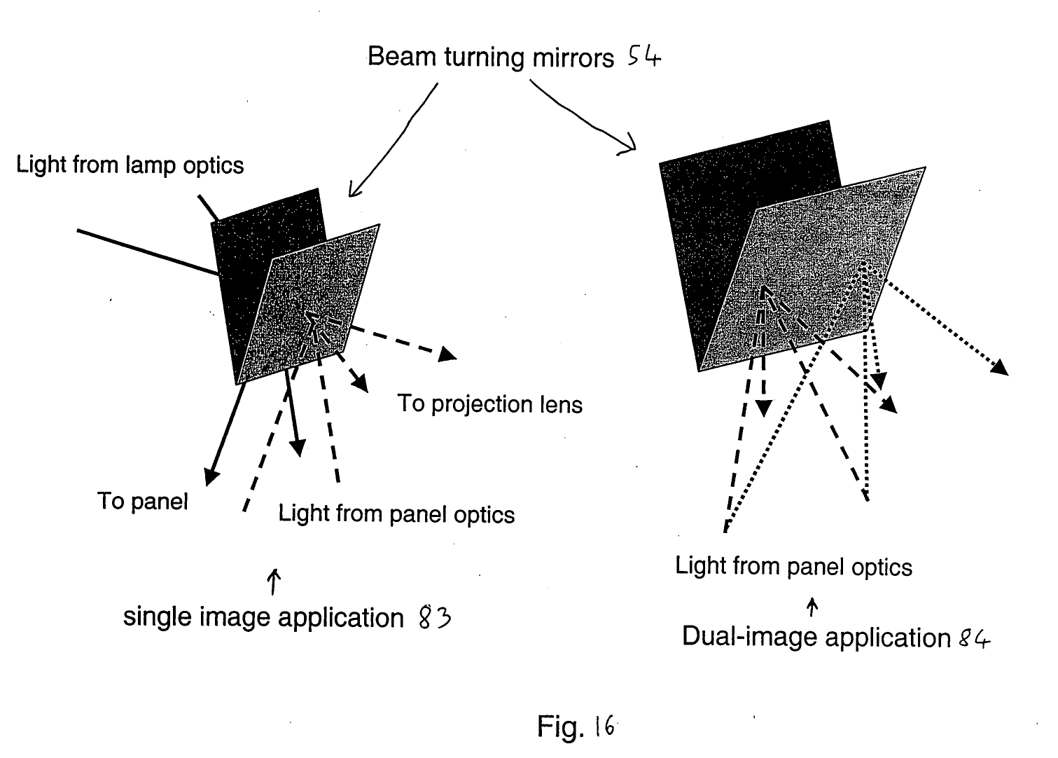

The LCD 51 displays image 1 and image 2 at different display regions 51a and 51b aligned with the sub-elements 55a and 55b, respectively. These images are angularly separated as shown in FIG. 15 by the front optical element 55 and are projected by the lens 56 so as to be displayed side-by-side on the projection screen, which may be a directional reflective or transmissive screen or a wide angle reflective or transmissive screen. The adapter 50 illustrated in FIGS. 14 and 15 may be capable of operating in either single-image or dual-image applications or modes. For example, for use in the single-image mode, the multiple sub-element arrangement may be replaced by a single front element arrangement with the light path from the panel optics to the projection lens being as illustrated at 83 in FIG. 16. Conversely, when the adapter is used in the dual-image mode, the light paths from the panel optics to the projection lens are as illustrated at 84 in FIG. 16.

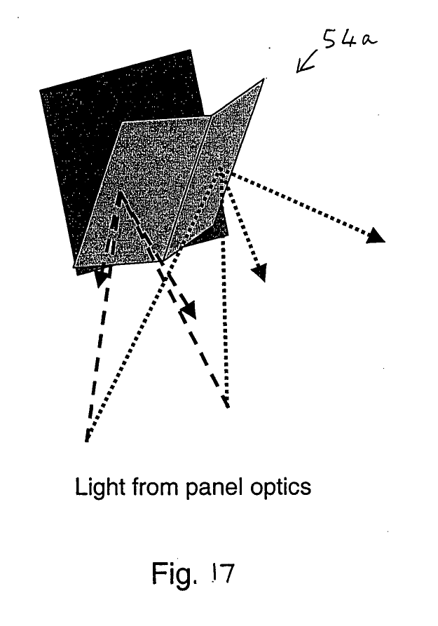

In order to increase the angular separation of the two projected images, a double-faceted beam steering optic 54a of the type illustrated in FIG. 17 may be used. In this case, the reflector facing the entrance pupil of the projection section comprises two reflectors which are not in a common plane but, instead, are angled with respect to each other so as to increase the image separation at the projection screen.

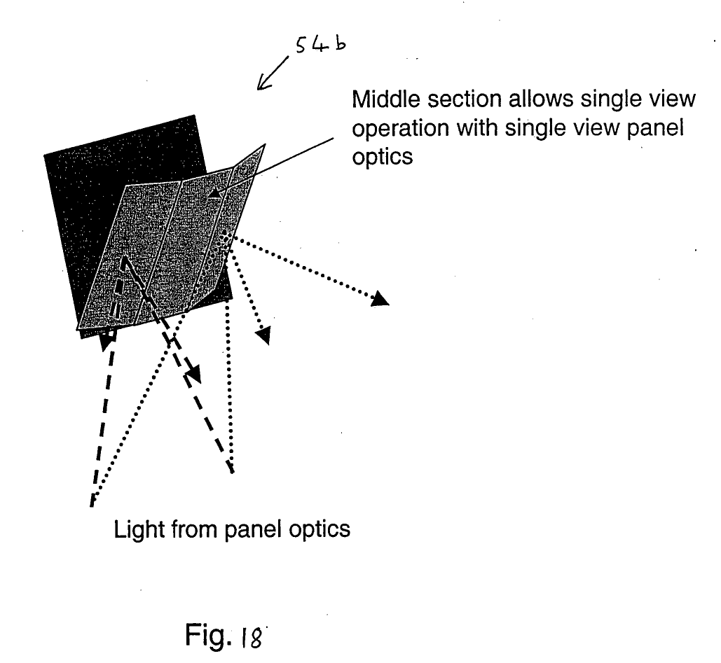

FIG. 18 illustrates a further arrangement permitting operation in the dual-image mode with increased angular separation or in the single-image mode without the need to replace the beam turning mirrors 54. In this case, a three-faceted mirror 54b is provided for reflecting light to the entrance pupil of the projection section. The middle section is oriented as illustrated at 83 in FIG. 16 and reflects light to the entrance pupil during the single-image mode of operation. In the dual-image mode, light is reflected by the other two facets, which are oriented as illustrated in FIG. 17.

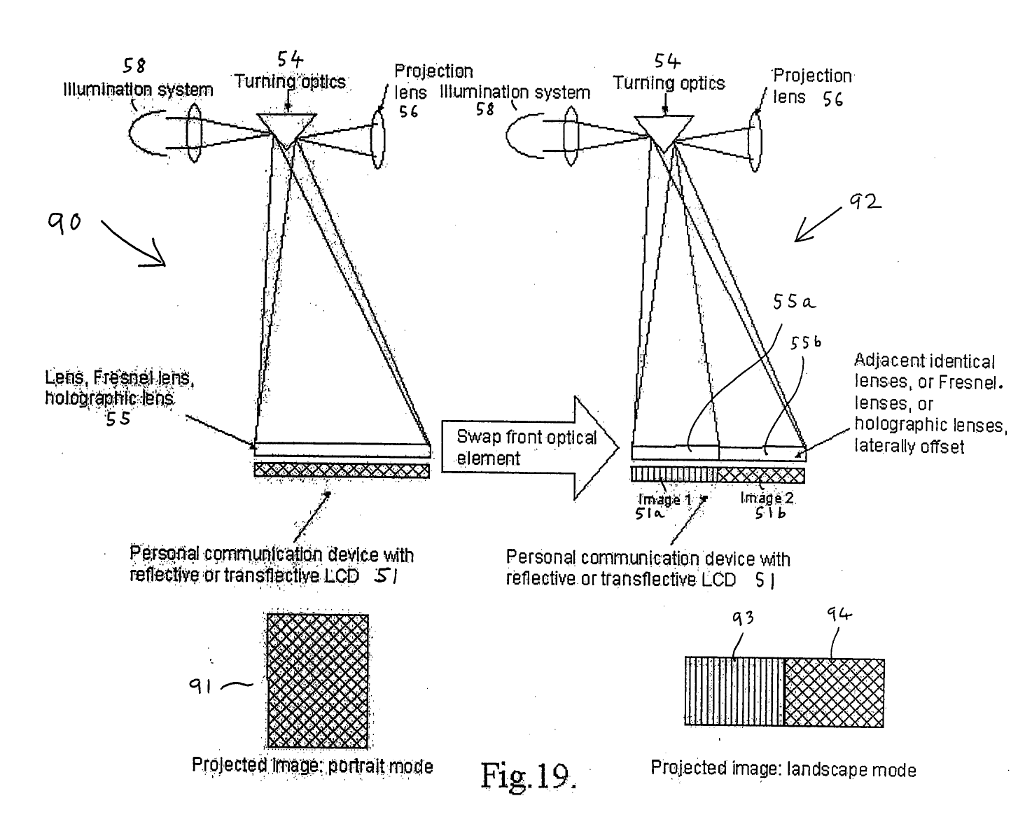

FIG. 19 illustrates an arrangement which allows operation in either “portrait” or “landscape” modes by changing between a single front optical element 55, for example as illustrated in FIG. 4, and a double front optical element 55a, 55b, for example as illustrated in FIG. 14. When this arrangement is to be used in the “portrait mode”, the single front optical element 55 is used as illustrated at 90 and the projected image has the aspect ratio illustrated at 91.

When this arrangement is to be used for the landscape mode as illustrated at 92, the single element 55 is replaced by the two elements 55a and 55b and the display 51 displays image 1 at the region 51a and image 2 at the region 51b. This arrangement therefore operates in the same way as the arrangement shown in FIG. 14 with the projected images 93 and 94 being disposed side-by-side and contiguously.

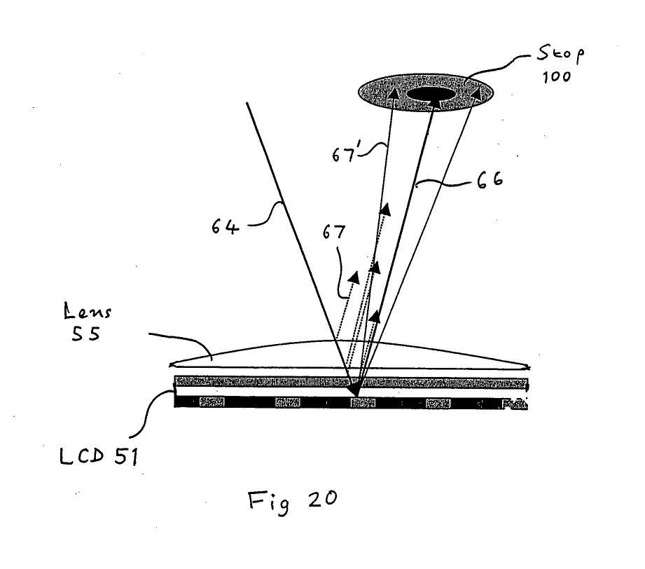

FIG. 20 illustrates part of the display adapter shown in FIG. 5 having a stop 100 defining a stop aperture associated with the projection optics. Incoming light is illustrated at 64 and, after modulation by the LCD 51, is directed through the stop aperture along the path 66. However, Fresnel reflection occurs at various interfaces and results in light being reflected or scattered along light paths such as those illustrated at 67 and 67′. The stop 100 blocks light travelling on such paths and thus improves the contrast of the projected image.

1. A projection adapter for cooperating with one of a direct view reflective display and a direct view transflective display, which is physically distinct from said adapter, to form a projected enlarged image of an image displayed by said display, said adapter comprising an illumination section, a projection section and a support arrangement supporting said illumination section and said projection section.

2. An adapter as claimed in claim 1, in which said support arrangement comprises an attachment for removeably attaching said adapter to said display.

3. An adapter as claimed in claim 1, comprising a front optical element for overlying said display at least when said adapter is in use.

4. An adapter as claimed in claim 3, comprising an illumination light path and a projection light path, said front optical element being disposed in said illumination light path and in said projection light path at least when said adapter is in use.

5. An adapter as claimed in claim 3, in which said front element is an optically converging element.

6. An adapter as claimed in claim 3, in which said front element is a lens.

7. An adapter as claimed in claim 6, in which said lens is a Fresnel lens.

8. An adapter as claimed in claim 3, in which said front element is a hologram.

9. An adapter as claimed in claim 8, in which said hologram is a volume transmission hologram.

10. An adapter as claimed in claim 8, in which said hologram is supported by said support arrangement.

11. An adapter as claimed in claim 8, in which said hologram is part of said display.

12. An adapter as claimed in claim 11, in which said display has an image forming part and said hologram overlies said image-forming part.

13. An adapter as claimed in claim 3, in which said illumination section forms a first image of a light source and said front element forms a second image of said light source laterally spaced from said first image at least when said adapter is in use.

14. An adapter as claimed in claim 13, in which said display has a display surface and each line from each of said first and second images perpendicularly intersecting a plane containing said display surface intersects said plane outside said display surface.

15. An adapter as claimed in claim 1, comprising a reflector for forming a bent illumination light path.

16. An adapter as claimed in claim 1, comprising a reflector for forming a bent projection light path.

17. An adapter as claimed in claim 13, comprising a first reflector for forming a bent illumination light path and a second reflector for forming a bent projection light path, said first and second images being formed substantially at said first and second reflectors, respectively.

18. An adapter as claimed in claim 17, in which the first and second reflectors comprise facets of a reflective prism.

19. An adapter as claimed in claim 1, in which said projection section comprises a projection optic.

20. An adapter as claimed in claim 19, comprising a stop defining an input aperture to said projection optic.

21. An adapter as claimed in claim 1, in which said illumination section comprises a condensing optic.

22. An adapter as claimed in claim 1, in which said illumination section comprises a light source.

23. An adapter as claimed in claim 22, in which said light source comprises a plurality of differently coloured light emitters.

24. An adapter as claimed in claim 23, in which said differently coloured emitters are arranged to operate time-sequentially.

25. An adapter as claimed in claim 1, in which said projection section comprises a polariser.

26. An adapter as claimed in claim 1, comprising a projection screen supported by said support arrangement.

27. An adapter as claimed in claim 3, in which said front element comprises a plurality of sub-elements which are laterally offset from each other.

28. An adapter as claimed in claim 27, comprising a reflector for forming a bent projection light path, said reflector comprising a plurality of non-parallel reflecting surfaces.

29. A combination of one of a direct view reflective display and a direct view transflective display and a projection adapter for cooperating with said display, which is physically distinct from said adapter, to form a projected enlarged image of an image displayed by said display, wherein said adapter comprises an illumination section, a projection section and a support arrangement supporting said illumination section and said projection section.

30. A combination as claimed in claim 29, in which said display is part of a communication device.

31. A combination as claimed in claim 30, in which said device is a mobile cellular telephone.

32. A combination as claimed in claim 29, in which said display is part of a personal digital assistant.

33. A combination as claimed in claim 29, in which said display is part of a personal game console.

34. A combination as claimed in claim 29, in which said display is at least part of an in-vehicle display.

35. A combination as claimed in claim 29, in which said display is a liquid crystal display.
